(19) United States
(12) Patent Application Publication
(10) Pub. No.: US 2024/0028073 A1
(43) Pub. Date: Jan. 25, 2024

(54) Mobile App Controlled Emoji Display Pendant

(71) Applicant: David Hart, Phoenix, AZ (US)

(72) Inventor: David Hart, Phoenix, AZ (US)

(21) Appl. No.: 17/872,197

(22) Filed: Jul. 25, 2022

(51) Int. Cl. A44C 25/00; G06F 1/16; G06F 3/147

(52) U.S. Cl. CPC A44C 25/001; G06F 1/163; G06F 3/147

(57) ABSTRACT

The present invention is comprised of a pendant with a wearable display (functional jewelry) and accompanying mobile app that allow users to choose an emoji/image from the app for display on the pendant. The invention will transmit image data (jpegs, gifs) from its mobile app for wireless pickup by the “Emogems” pendant (AMOLED 1.4″ round display). One image/emoji will be displayed on the pendant at a time, although the user will be able to replace displayed images at will by making selections from the emoji library on the app. When no emoji is selected, while the display is on, the Emogems logo is visible on the display as a default image. Most images/emoji will be static, but some include animated gifs that animate indefinitely.

### FIELD OF THE INVENTION

The present invention relates to functional jewelry and wearable electronic devices. More specifically, the invention relates to an electronic pendant with a display controlled wirelessly by its accompanying mobile app.

### BACKGROUND OF THE INVENTION

In recent years, emojis have unofficially become a new, universal language. No longer used only for communicating expressions and reactions for social purposes, they are now broadly incorporated into business and professional correspondence. The option to use them with or without text has been built into a wide range of software and operating systems, from mobile device texting to desktop publishing applications. Furthermore, Unicode (the foundation for the digital representation of languages and symbols) now incorporates emojis as well as several font packages.

This creates a unique opportunity for a new form of social interaction. By simply displaying an emoji around one's neck, in a pendant fashion, a user can visually “speak” a wide range of emotions without uttering a single word. The user may communicate joy, sadness, excitement, nationality, a hobby/interest, and so on to everyone that views his/her pendant and potentially elicit verbal reactions, prompting conversation and dialogue that would not occur otherwise. In addition, the chance to introduce a new form of jewelry also exists, where the user can change the content of his/her pendant to whatever they choose whenever they want.

### BRIEF SUMMARY OF THE INVENTION

As embodied and broadly described herein, the present invention is a wearable display pendant (functional jewelry) and accompanying mobile app system that sends image data from the Emogems mobile app to the Emogems pendant (round LED display, printed circuit board, battery and housing) wirelessly, utilizing Bluetooth as a delivery mechanism.

Firstly, users can choose a static or animated emoji/image from the Emogems mobile app library for display on the front of the pendant. One emoji/image is displayed on the pendant at a time, although the user can replace displayed images at will by making selections from the app library. When no emoji is selected, while the display is on/awake, the Emogems logo is visible on the display as a default image. After roughly two minutes of inactivity/motion, the pendant goes to “sleep” (display turns off). When motion is initiated again, the pendant “wakes up” (turns back on).

Secondly, additional usage opportunities exist. For example, two users can engage in a game of “Rock, Paper, Scissors” where both simultaneously initiate a randomize function between three corresponding emojis. Trending memes can also be introduced via the app library, as well as regular emoji updates to remain current with new and changing symbols. A membership option may also be made available, where users are granted additional freedoms and customization features such as adding unique images to a personal library within the app for individual pendant display.

### BRIEF DESCRIPTION OF THE DRAWINGS

FIG. 1-FIG. 1 is a front view of the pendant.

FIG. 2-FIG. 2 is a back view of the pendant.

FIG. 3-FIG. 3 is a view of the left side of the pendant.

FIG. 4-FIG. 4 is a view of the right side of the pendant.

FIG. 5-FIG. 5 is a top view of the pendant.

FIG. 6-FIG. 6 is a bottom view of the pendant.

FIG. 7-FIG. 7 is an exploded front view of the pendant housing.

FIG. 8-FIG. 8 is an exploded back view of the pendant housing.

FIG. 9-FIG. 9 is an illustration of the printed circuit board (PCB).

FIG. 10-FIG. 10 is an illustration of the round LED display.

FIG. 11-FIG. 11 is an illustration of the Emogems mobile app library.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new wearable device in the form of functional jewelry and corresponding mobile app software is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

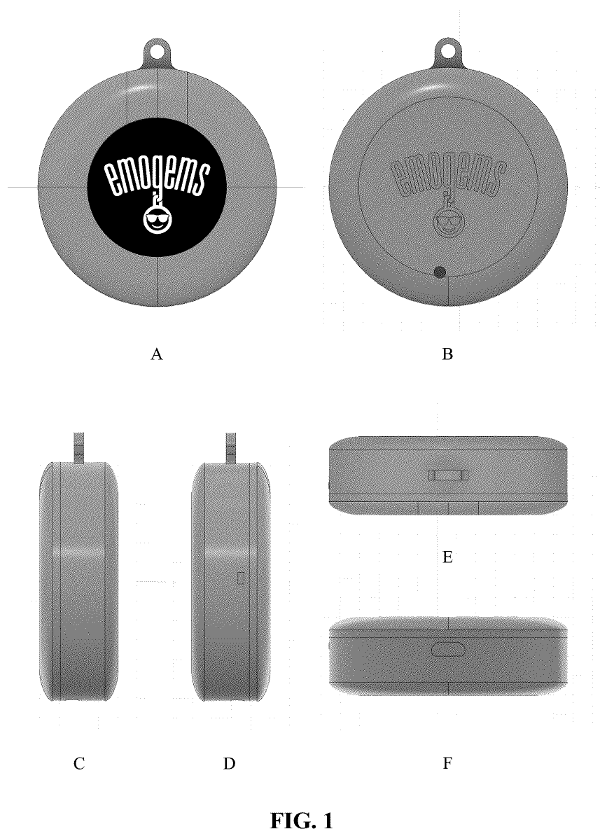

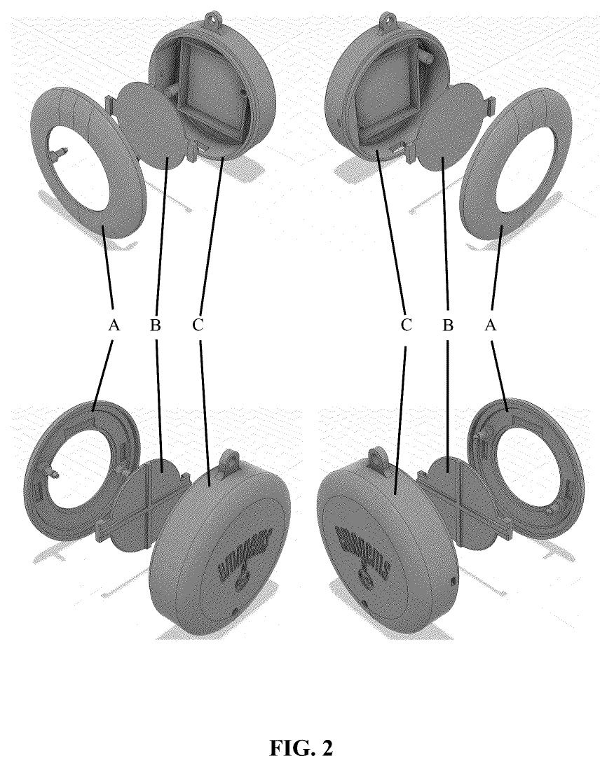

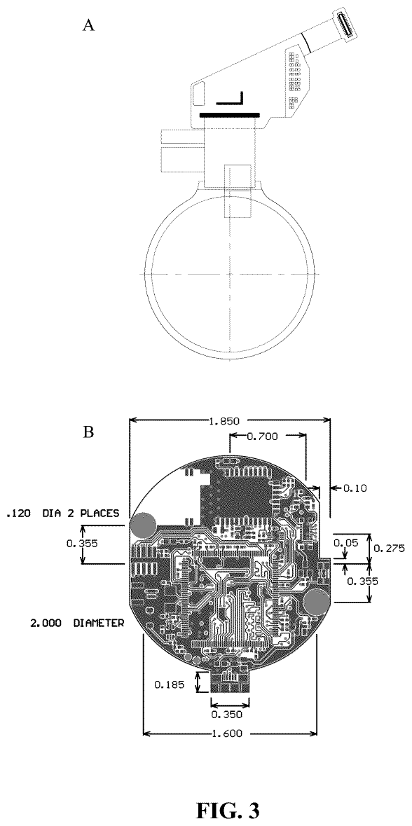

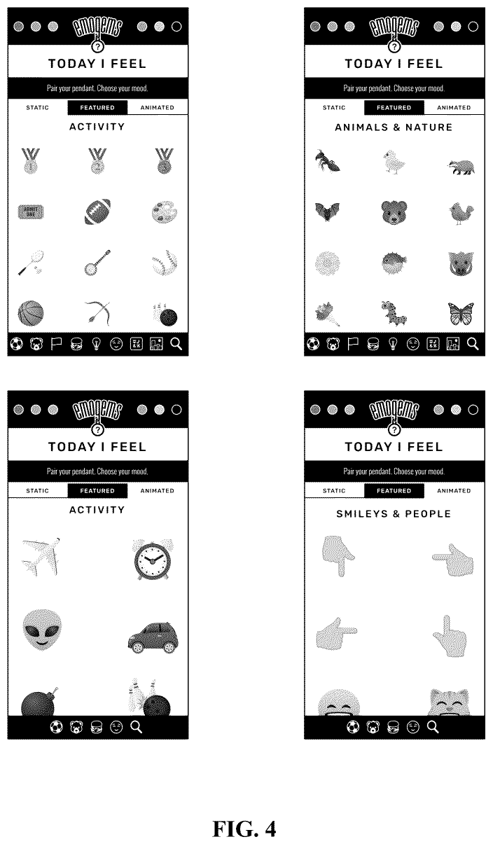

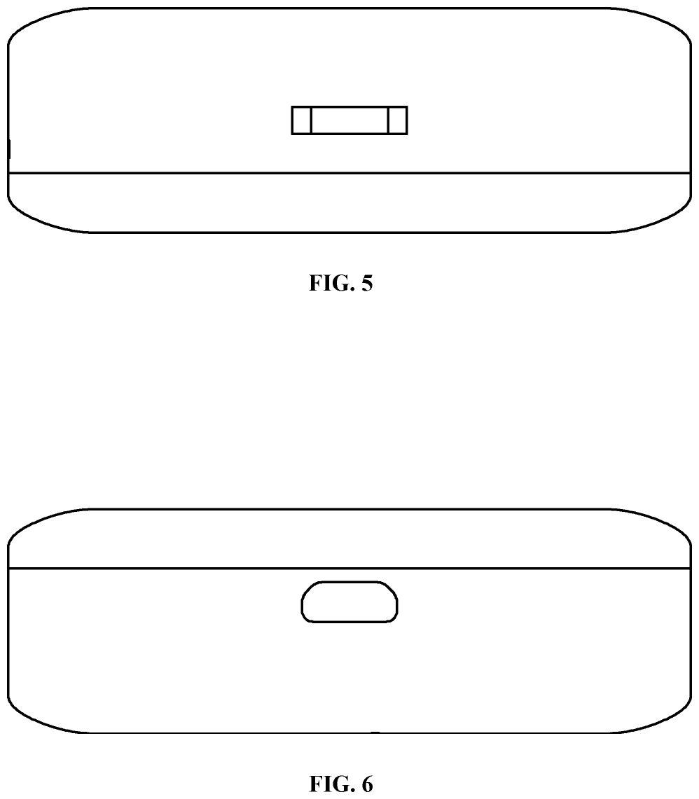

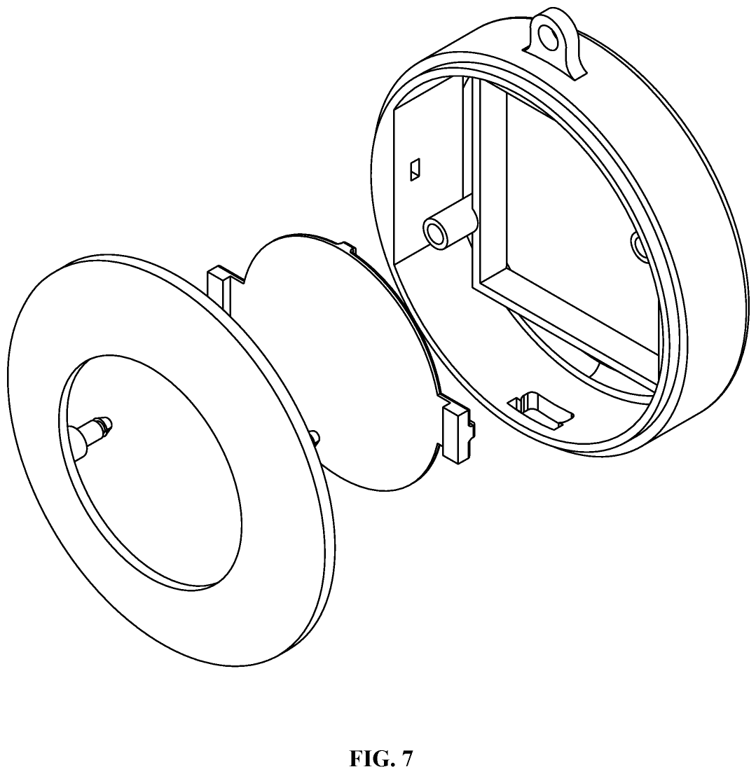

The present invention will now be described by referencing the appended figures representing preferred embodiments. FIG. 1 depicts a standard view of the Emogems pendant as a whole. It is intended to hang around the user's neck, as a necklace with a pendant attached. The screen display where the selected emoji is viewable is on the front. When an emoji from the Emogems library has not been selected and transmitted to the pendant, the Emogems logo is displayed as a default image, as illustrated.

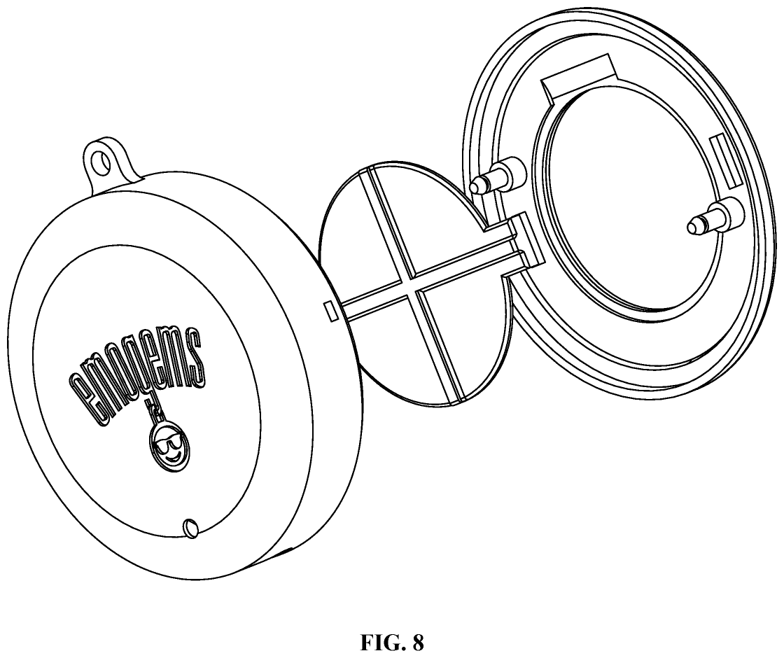

FIG. 7 and FIG. 8. illustrate an exploded view of the pendant housing. The housing is composed of three parts: front, display backer/support and back where the PCB is attached and the rechargeable battery is inserted.

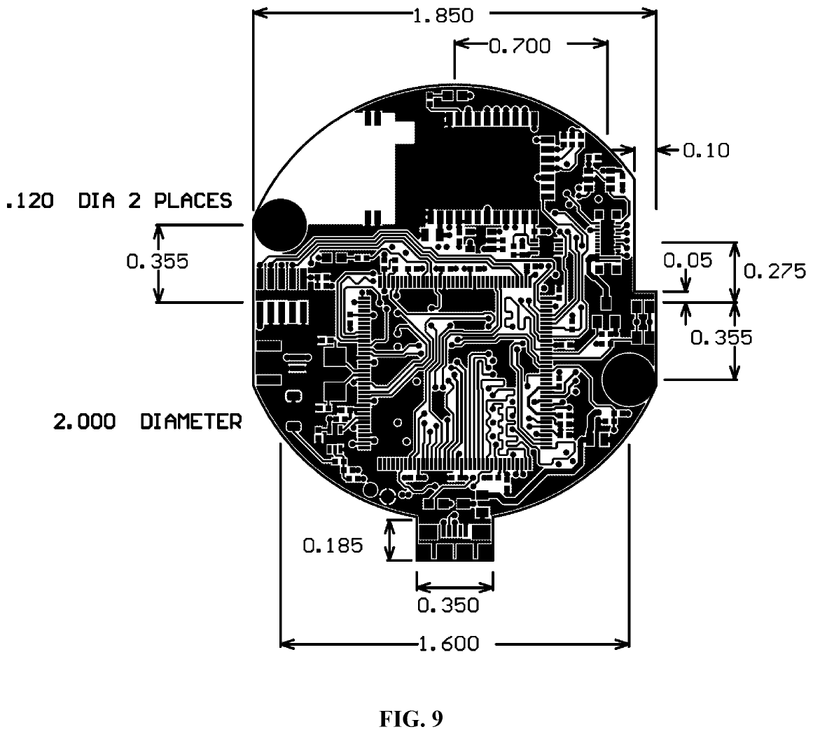

FIG. 9 illustrates the round LED display.

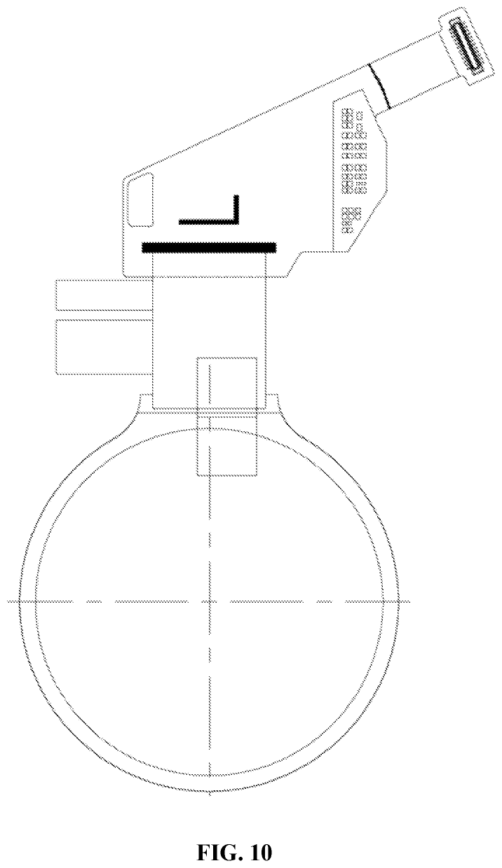

FIG. 10 illustrates the the printed circuit board (PCB).

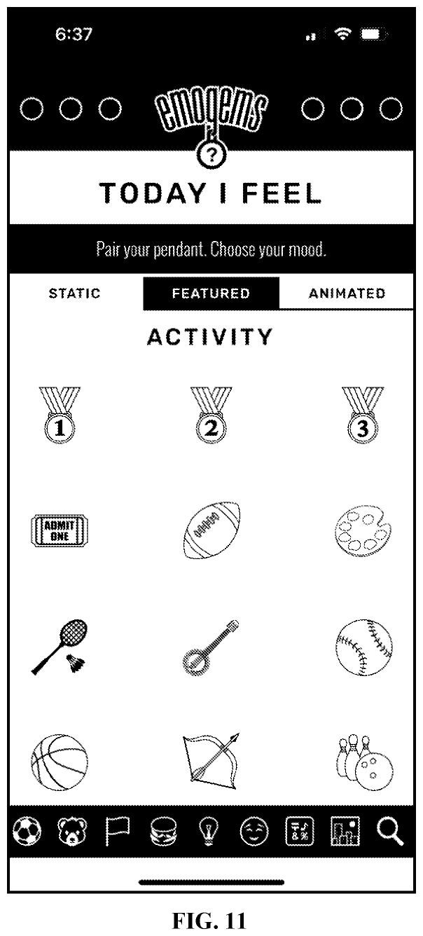

FIG. 11 illustrates the accompanying Emogems mobile app interface.

What is claimed is:

1. The apparatus of claim 1 wherein said pendant receives data (emoji/images) from said proprietary mobile app. The apparatus of claim 1 wherein said pendant utilizes Bluetooth wireless technology to transmit emoji/image data from said mobile app. The apparatus of claim 1 wherein said pendant utilizes a round OLED (Organic Light Emitting Diode) display. The apparatus of claim 1 wherein said pendant hangs around the user's neck as a necklace/jewelry.
